(19) United States
(12) Patent Application Publication
(10) Pub. No.: US 2006/0177284 A1
(43) Pub. Date: Aug. 10, 2006

(54) Method for preparing pre-coated aluminum and aluminum-alloy fasteners and components having high-shear strength and readily deformable regions

(75) Inventors: Steven G. Keener, Trabuco Canyon, CA (US); Edward Litwinski, Mission Viejo, CA (US); Max Runyan, Huntington Beach, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: THE BOEING COMPANY

(21) Appl. No.: 11/052,319

(22) Filed: Feb. 7, 2005

(51) Int. Cl. F16B 19/08

(52) U.S. Cl. 411/501

(57) ABSTRACT

A fastener component is formed from aluminum or aluminum-alloy material having a head portion and an elongate shank portion, the shank portion having an end and intermediate or transition region. At least the shank portion of the fastener is cold-worked or heat-treated to an intermediate hardness stage, typically to a T6 condition. The intermediate region of the shank portion is further cold-worked to harden or strengthen the intermediate region of the shank portion with respect to the end of the shank, typically to a T8 condition. The aluminum or aluminum-alloy material of the component advantageously has ultra-fine grain size of less than about 5 microns. The ultra-fine grain size is advantageously obtained by friction stir processing (FSP) or equal angle extrusion (EAE).

### FIELD OF THE INVENTION

The present invention relates to fastener components and, more particularly, relates to a method of manufacturing fastener components having high-shear strength while maintaining formability.

### BACKGROUND OF THE INVENTION

Structural assemblies are commonly formed by joining two or more structural members using fasteners, such as solid deformable-shank, one-piece rivets. In the aerospace industry, where weight and strength are of critical concern, the joints of structural assemblies typically are subjected to repeated cycles of shear, compressive, and tensile stresses over the life of the assembly. As a result, the fasteners must have good mechanical strength and fatigue resistance without adversely affecting the overall weight of the structural assemblies. In addition, because the structural assemblies may be exposed to the ambient environment, including moisture exposure and temperature fluctuations, the joints must be secured with fasteners having good corrosion resistance and resistance to thermal stresses. To address the strength and weight requirements, fasteners, particularly conventional solid one-piece rivets, are typically formed of materials having high strength-to-weight ratios, such as aluminum and aluminum alloys that have been hardened by cold working or precipitation hardening. Advantageously, a number of high-strength aluminum alloys materials are available that are lightweight, and also have relatively high fatigue and corrosion resistance. Unfortunately, when in the hardened condition, high-strength aluminum-alloy materials tend to lack the formability that is necessary during manufacture and installation of the sold one-piece rivets, which can result in failure by necking, cracking or tearing.

In seeking to solve the problems associated with poor formability, modifications to the manufacturing process for producing the fasteners and fasteners components have been proposed. One such modification includes producing the fasteners, such as deformable rivets, from an aluminum-alloy material that is in a soft condition and, thereafter, heat treating the fastener, such as by precipitation hardening, to thereby harden the fastener prior to its installation and use. The increase in formability of aluminum-alloy materials in a soft condition reduces the likelihood that the fastener will fail as a result of necking, cracking, or tearing during manufacture. However, heat treating reduces the general formability of the fastener which, as noted above, can result in failure during installation. Heat treating also adds an additional step during manufacture, which increases the manufacturing costs associated with the production of the fasteners and contributes to the increased costs associated with the resulting structural assemblies.

Accordingly, there exists a need for an improved method for manufacturing fasteners and fastener components. The method should provide fasteners having high formability to reduce the likelihood of necking, cracking, or tearing during the manufacture and subsequent installation and use of the fasteners. The method also should be cost effective so as not to adversely affect the manufacturing cost of the fasteners and the subsequent costs associated with the resulting structural assemblies. In addition, the fasteners should be capable of being formed from materials that have high strength-to-weight ratios, and that exhibit high fatigue and corrosion resistance, as well as resistance to thermal stresses.

### SUMMARY OF THE INVENTION

The present invention is a one-piece fastener component having a head portion and a shank portion. The shank portion has an end region opposing the head and an intermediate or transition region between the end region and the head, wherein the intermediate or transition region has greater shear strength relative to the end region and the end region is more readily deformable in comparison to the intermediate region. The one-piece fastener component is well suited for installations in which the end of the shank portion has greater formability to facilitate upset upon installation but in which the intermediate segment of the fastener has high-shear strength properties, relative to the end of the shank portion.

The component is advantageously formed from an aluminum or aluminum-alloy material blank. The blank is formed into the shape of a one-piece fastener component having a head portion and an elongate shank portion. The intermediate or transition region of the shank is cold-worked to a greater extent than the end region of the shank. The fastener component is thereafter heat-treated, for example, such that the end portion of the shank results in an intermediate hardness stage, typically to the T6 condition, while the intermediate or transition region of the shank portion which results in a higher-strength condition, relative to the end region, typically to a T8 condition.

By cold-working the intermediate or transition region of the shank portion to a greater degree than the end region of the shank portion, the hardness of the intermediate region may be optimized for high shear-strength properties while the end region retains its highly deformable characteristics.

According to one embodiment of the invention, the blank is formed of an aluminum or aluminum-alloy material having ultra-fine grain size, i.e. average grain size of less than about 5 microns. The ultra-fine grain size is advantageously obtained by friction stir processing (FSP) or equal angle extrusion (EAE). The ultra-fine grain microstructure of the resulting component provides the component with increased strength in comparison to previous one-piece fastener components formed from traditional aluminum-alloy materials. The overall manufacturing process for aluminum and aluminum-alloy material fasteners can be shortened by using either the FSP or EAE processed fine-grain material to produce a component in the “as-formed” condition directly from either the FSP or EAE processed material without the need for additional, in-process thermal treatment steps.

The invention encompasses the fastener or fastener component formed of an aluminum or aluminum-alloy material, advantageously ultra-fine grain size material, having a head portion and a shank portion, composed of an intermediate or transition region, and end region wherein the intermediate region is cold-worked to a greater extent than the end region, thereby providing grain structure characteristic of high-shear strength state in the intermediate shank region and grain structure characteristic of a readily deformable state in the end shank region. The cold-work or strain imported to the center shank-section could also be used with an aging cycle to heat treat this section to the T8 condition. The invention also encompasses methods of forming the fastener or fastener component and structures, particularly aerospace structures, fastened together with the fastener or fastener components.

### BRIEF DESCRIPTION OF THE DRAWINGS

Having thus described the invention in general terms, reference will now be made to the accompanying drawings, which are not necessarily drawn to scale, and wherein:

FIG. 1 is a schematic sectional view representing an exemplary molding process used to form an intermediate stage of the fastener component in accordance with one embodiment of the invention;

FIG. 2 is a schematic sectional view representing an exemplary molding process used to form the invented fastener component from the intermediate stage component of FIG. 1 in accordance with one embodiment of the invention;

FIG. 3 is a schematic sectional view of a flush-head one-piece fastener or rivet according to an embodiment of the invention used to join two pieces, prior to upsetting; and

FIG. 4 is a schematic sectional view of the flush-head one-piece fastener or rivet of FIG. 3, after upsetting.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The fastener component is made from an aluminum or aluminum-alloy material blank. The aluminum material may be any cast or wrought aluminum-alloy material, which includes pure aluminum, and is advantageously selected from 2000, 4000, 6000, and 7000 series aluminum alloys.

The fastener component is advantageously made from an aluminum or aluminum-alloy material having an ultra-fine grain size. The blank and resulting component advantageously has a refined grain structure with an average grain size of less than about 0.0002 inch (approximately 5 microns). Advantageously, the fastener component is formed of a metal or metal alloy such that the fastener component comprises a refined grain structure with an average grain size ranging in order of magnitude from approximately 0.0001 to approximately 0.0002 inch (approximately 3 to 5 microns) and having equiaxed shape.

The ultra-fine grain size may be obtained by subjecting an aluminum or aluminum-alloy material workpiece to a friction stir process (FSP). Friction stir processing generally involves solid state mixing of a metal workpiece by moving a solid tool through the workpiece, thereby generating heat by friction and temporarily plasticizing the metal. Friction stir processing include friction stir welding (FSW) processes as described in U.S. Pat. No. 6,726,085 and U.S. patent application Ser. No. 10/145,342, filed May 14, 2002, both of which are incorporated herein by reference to the extent that they do not conflict with the instant disclosure. According to the '085 process, a workpiece is forced through a die that defines first and second apertures and an interior therebetween. The first aperture and the interior of the die are structured to receive the workpiece. The apparatus includes at least one rotatable pin extending at least partially into the interior of the die. The pin is structured to at least partially stir the workpiece as the workpiece moves through the interior of the die to thereby refine the grain micro structure of the workpiece. The interior of the die can be structured to shape the workpiece into a pre-determined configuration, such as a square, rectangle or cylinder, to thereby cost effectively combine the operations of shaping the workpiece and refining the grain micro structure of the workpiece. There may be one or multiple rotatable pins, they may be motorized or non-motorized, and multiple rotatable pins may rotate in common or opposing directions.

According to the FSW method disclosed in U.S. patent application Ser. No. 10/145,342, the refined grain microstructure is formed by mixing or stirring at least a portion of a workpiece with a non-consumable rotating friction stir welding probe. To effect mixing of the workpiece, the friction stir welding probe is attached to a rotatable spindle which, in turn, rotates the probe. The rotatable spindle is preferably adapted to move the probe parallel to the surface of the workpiece. As the friction stir welding probe is forced through the outer surface of the workpiece, friction is generated between the probe and the workpiece. The friction generates sufficient heat energy to plasticize the adjacent portions of the workpiece proximate to the probe. The probe can be moved randomly at will throughout the workpiece or along a pre-determined path that is chosen so as to friction stir weld or mix a certain region or regions of the workpiece.

The entire workpiece or a region thereof may be processed using FSW. Regions of the workpiece having an unrefined grain microstructure can be subsequently removed from the workpiece, for example by machining the workpiece, resulting in a blank substantially comprised of a region or regions of the workpiece having refined grain microstructure. The blank also can be obtained by forming or punching the blank from the region or regions of the workpiece having refined grain microstructure.

Upon cooling, the region or regions of the workpiece that were mixed during the FSW process by the rotating probe have a refined grain microstructure with ultra-fine grain size, i.e. about 3 to about 5 microns. The refined grain microstructure exhibits improved strength, toughness, ductility, fatigue resistance, and corrosion resistance so that the material will resist the formation and propagation of cracks.

Alternatively, the refined grain microstructure and ultra-fine grain size may be introduced to the aluminum or aluminum-alloy material through a process known as “equal angle extrusion.” Equal angle extrusion involves forcing a workpiece, using pneumatic or hydraulic pressure, through a forming die having approximately a 90° bend. In theory, equal angle extrusion mechanically cold works the existing grain structure of the workpiece as it is forced through the die such that the resulting material exiting the extrusion die will archive a reduction in grain size. An example of equal angle extrusion is shown in U.S. Ser. No. 10/331,672, filed Dec. 30, 2002, published as U.S. Pat. Pub. No. 2004/0123638, incorporated herein by reference to the extent it does not contradict the instant disclosure.

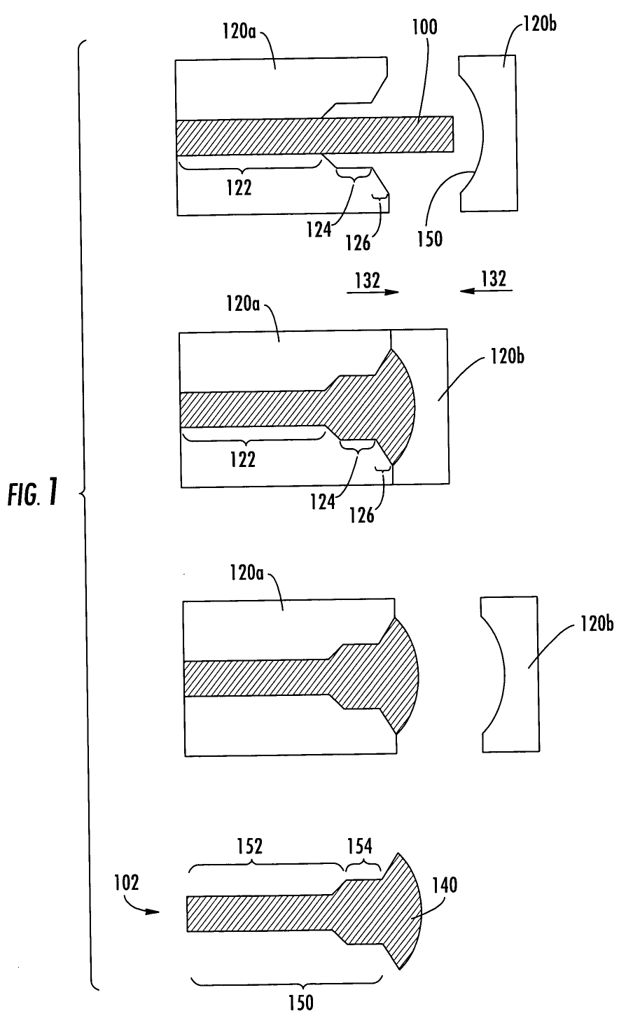

The fastener component is formed from the blank. Referring to FIG. 1, and according to one embodiment, the formation of a one-piece fastener, i.e. a rivet, is shown as an example of the invented fastener component. According to the example shown, a cylindrical rod or blank 100 is inserted into a separable die having a first section 120a dimensioned with a first bore or tubular section 122 of a first diameter approximately the same diameter as that of the blank 100, an adjacent second bore or tubular section 124 coaxial with the first bore or tubular section 122 having a second diameter greater than the first bore diameter, and a head section 126 adjacent to the end or termination of the second above or tubular section 124 and having a cross section greater than the second bore diameter. The second or end section 120b of the die has a surface 130 that compacts the blank in the longitudinal direction as the die is closed in the direction indicated by arrows 132.

Upon closure of the die, the second section 120b of the die contacts and deforms the cylindrical rod or blank 100 such that the blank substantially fills the second tubular section 124 and head section 126 of the die 120. The resulting formed fastener component 102 has a head portion 140 and a shank portion 150. The shank portion 150 has an end region 152 opposing the head and an intermediate region 154 between the end region 152 and the head portion 140, wherein the intermediate region 154 of the shank portion has a larger diameter that the end region 152.

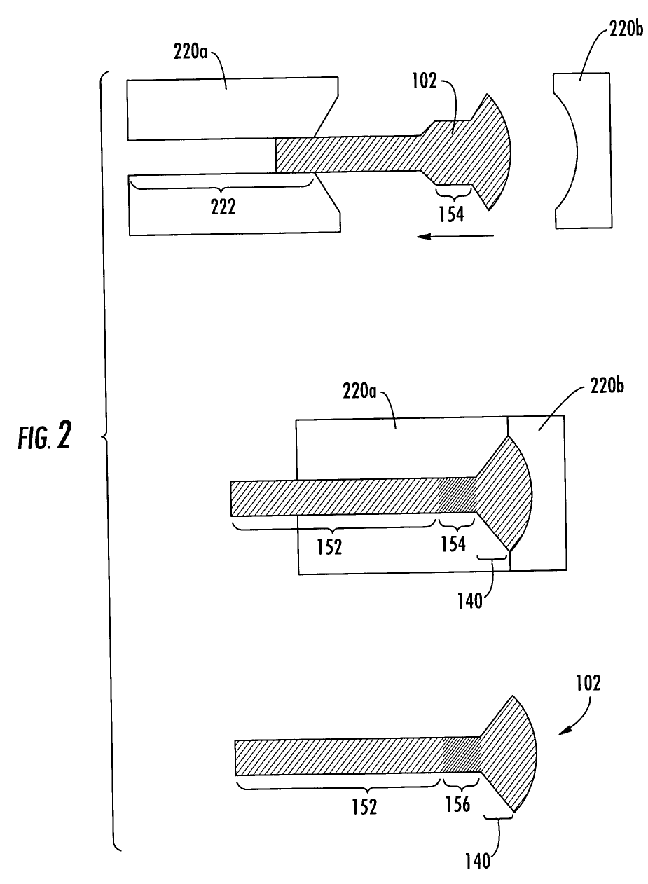

As shown in FIG. 2, the fastener component 102 is inserted and pressed into a tubular die having a bore or tubular region 222 of constant diameter approximately equal to the diameter of the end region 152 of the fastener component 102. As the intermediate region 154 of the shank portion is pressed into the bore or tubular region 222 of the die 220, the diameter of the intermediate region 154 is forcibly reduced, and thereby cold-worked, reduced to the diameter of the end region of the shank portion 152, resulting in a fastener component 102 having a shank portion 150 with an end region 152, a reduced-diameter intermediate region 156, which has been cold-worked to a greater extent than the end region, and a head region 140, which is advantageously cold-worked to any pre-determined desirable strength level. According to an alternative embodiment, the intermediate region of the shank portion may be cold-worked by using traditional rolling or swaging techniques in lieu of the cold-working method represented by FIG. 2.

The supplemental cold-working of the intermediate region places the intermediate region of the shank portion into a higher shear strength condition than the end region. The different amount of cold-working results in differing grain structures of the intermediate region relative to the end region of the shank. For use as a fastener in aerospace applications, the end region of the shank is advantageously hardened to a T6 condition and the intermediate region is advantageously hardened to the T8 condition. For example, a blank may be provided in a T4 condition, and the head and intermediate region cold-worked to the T3 condition, while the end region remains in the T4 condition. Thus, the end region of the shank is softer than the intermediate region of the shank. Similarly, upon heat-treatment, the cold-worked head and intermediate portion of the shank convert to the T8 condition while the end region converts to a T6 condition. In either situation, the end region may be easily upset upon installation of the component while the intermediate region provides increased shear strength to the intermediate region.

After the completion of cold-working, the fastener component 102 may be pre-coated. According to one embodiment, a coating material is provided, preferably in solution so that it may be readily and evenly applied. The usual function of the coating material is to protect the base metal to which it is applied from corrosion, including, for example, conventional environmental corrosion, galvanic corrosion, and stress corrosion. The coating material is a formulation that is primarily of an organic composition, but which may contain additives to improve the properties. It is desirably initially dissolved in a carrier liquid so that it can be applied to a substrate. After application, the coating material is curable to effect structural changes within the organic component, typically cross linking of organic molecules to improve the adhesion and cohesion of the coating.

A wide variety of curable organic coating materials are available. A typical and preferred coating material of this type has phenolic resin mixed with one or more plasticizers, other organic components such as polytetrafluoroethylene, and inorganic additives such as aluminum powder and/or strontium chromate. These coating components are preferably dissolved in a suitable solvent present in an amount to produce a desired application consistency. For the coating material just discussed, the solvent is a mixture of ethanol, toluene, and methyl ethyl ketone (MEK). A typical sprayable coating solution has about 30 weight percent ethanol, about 7 weight percent toluene, and about 45 weight percent methyl ethyl ketone as the solvent; and about 2 weight percent strontium chromate, about 2 weight percent aluminum powder, with the balance being phenolic resin and plasticizer as the coating material. A small amount of polytetrafluoroethylene may optionally be added. Such a product is available commercially as “Hi-Kote 1™” from Hi-Shear Corporation, Torrance, Calif. It has an elevated-temperature curing treatment of 1-4 hours at 350°-400° F., as recommended by the manufacturer. More preferably, the curing protocol consist of 1-1½ hours at 400°-450° F.

The coating material is applied to the untreated fastener component 102. Any suitable approach, such as dipping, spraying, or brushing, can be used. In the preferred approach, the solution of coating material dissolved in solvent is sprayed onto the untreated fastener components. The solvent is removed from the as-applied coating by drying, either at ambient or slightly elevated temperature, so that the coated article is dry to the touch in order to facilitate handling. The coated fastener component is not suitable for service at this point, because the coating is not sufficiently adhered to the aluminum-alloy base metal and because the coating is not sufficiently coherent to resist mechanical damage in service.

In the case of the preferred Hi-Kote 1™, the as-sprayed coating was analyzed by EDS analysis. The heavier elements were present in the following amounts by weight: Al, 82.4 percent; Cr, 2.9 percent; Fe, 0.1 percent; Zn, 0.7 percent; and Sr, 13.9 percent. The lighter elements such as carbon, oxygen, and hydrogen were detected in the coating but were not reported because the EDS analysis for such elements is not generally accurate.

In one embodiment, the base metal of the fastener component and the applied coating are together heated to a suitable elevated temperature to achieve two results simultaneously. In this single step, the aluminum-alloy material substrate is heat-treated to its final desired strength state, and the coating is cured to its final desired bonded state. Preferably, the temperature and time treatment is selected to be that required to achieve the desired properties of the aluminum-alloy base metal, as provided in the industry-accepted and proven process standards for that particular aluminum-alloy base material. This treatment may not produce the most optimal cure state for the coating, but it has been determined that the heat-treatment of the metal is less forgiving of slight variations from the optimal treatment than is the curing treatment of the organic coating. That is, the curing of the coating can sustain larger variations in time and temperature with acceptable results than can the heat-treatment of the metal. Thus, the use of the heat-treatment of the metal yields the optimal physical properties of the metal, and acceptable properties of the coating.

As an example, in the case of 7050 aluminum-alloy base material and Hi-Kote 1™ coating discussed above, the preferred heat-treating temperature is the T73 heat-treatment of 7050 alloy: 4-6 hours at 250° F., followed by a ramping up from 250° F. to 355° F. and maintaining the temperature at 355° F. for 8-12 hours, and an ambient air cool to ambient temperature.

Thus, the heat-treating procedure involves longer times at temperature and higher temperatures than is recommended for the organic coating. There was initially a concern that the higher temperatures and longer times, beyond those required for curing the coating, would degrade the coating. This concern proved to be unfounded. The final coating is strongly adherent to the base metal aluminum alloy and is also strongly internally coherent. The coating, typically about 0.0003-0.0005 inch thick as applied, remains unchanged after curing.

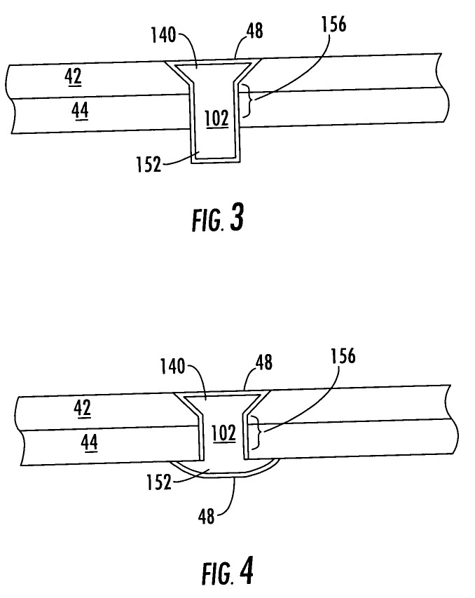

The coated and treated fastener is ready for installation. The fastener is installed in the manner appropriate to its type. In the case of a rivet 40, as shown in FIGS. 3 and 4, the rivet is placed through aligned bores in two pieces 42 and 44. The protruding end region of the shank 152 is upset (plastically deformed) so that the pieces 42 and 44 are captured between the head 140 and the upset end 152 of the rivet. The coating 48 is retained on the rivet even after upsetting. If the coating were not applied to the fastener, it would be necessary to place a viscous wet sealant material into the bores and onto the faying surfaces as the rivet was upset, to coat the surfaces. By utilizing the pre-coating process, wet sealant is not needed or used during fastener installation. The later-applied epoxy primer and topcoat paints adhere well over the coated rivet heads.

One of skill in the art will recognize that the invention, specifically described above with reference to a one-piece deformable fastener, is equally applicable to multi-piece fastener systems such as blind fasteners in which the sleeve of the blind fastener, i.e. a blind rivet, is fabricated such that the sleeve has an end region and an adjacent intermediate or transition region, wherein the intermediate or transition region has greater shear strength relative to the end region and the end region is more readily deformable in comparison to the intermediate region.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1-8. (canceled)

9. A method of forming a fastener component having a high-shear strength region and a readily deformable region, the method comprising:
providing an aluminum or aluminum alloy blank having ultra-fine grain size;
forming the blank into a shape of a fastener component having a head and an elongate shank having an end and intermediate region;
cold-working the intermediate region of the shank to a greater extent than the end of the shank; and,
heat-treating the shank and thereby hardening the intermediate region of the shank with respect to the end of the shank.

10. The method of claim 9, wherein the step of providing an aluminum or aluminum alloy blank comprises providing an aluminum or aluminum alloy blank having an average grain size less than about 5 microns.

11. The method of claim 10, wherein the step of providing an aluminum or aluminum alloy blank comprises subjecting an aluminum or aluminum alloy workpiece to a friction stir processing (FSP) technique in order to reduce the average grain size to less than about 5 microns.

12. The method of claim 10, wherein the step of providing an aluminum or aluminum alloy blank comprises subjecting an aluminum or aluminum alloy workpiece to an equal angle extrusion (EAE) technique in order to reduce the average grain size to less than about 5 microns.

13. The method of claim 9, further comprising of heat-treating the fastener component to a T4 hardness condition before cold-working the intermediate region of the shank.

14. The method of claim 13, wherein the intermediate region of the shank is heat-treated to a T8 condition.

15. The method of claim 9, further comprising applying a phenolic resin-containing organic coating to the component.

16. The method of claim 15, wherein the step of applying the phenolic coating comprises spraying the organic coating material onto the aluminum-alloy component, and thereafter removing any volatile constituents from the sprayed coating.

17. The method of claim 9, wherein the blank is formed into the shape of a fastener component having a head and an elongate shank having a cylindrical end region of a first diameter and a cylindrical intermediate region of a second diameter larger than the first diameter; and,
cold-working the intermediate region of the shank to reduce the diameter of the intermediate region down to the first diameter, thereby hardening the intermediate region of the shank with respect to the end of the shank.

18. A fastener component formed by the process recited in claim 9.

19. (canceled)
